(19) United States
(12) Patent Application Publication
(10) Pub. No.: US 2022/0103679 A1
(43) Pub. Date: Mar. 31, 2022

(54) Communication Application for Blind and Normal People with Deaf People (HOPE Tech)

(71) Applicants: Mohammadhossein Zare, Feasterville Trevose, PA (US); Aliakbar Sheikhy, Amol (IR); Asghar Akbary Kamangar, Babol (IR)

(72) Inventors: Mohammadhossein Zare, Feasterville Trevose, PA (US); Aliakbar Sheikhy, Amol (IR); Asghar Akbary Kamangar, Babol (IR)

(21) Appl. No.: 17/033,717

(22) Filed: Sep. 26, 2020

(51) Int. Cl. H04M 1/725; G09B 21/00

(52) U.S. Cl. CPC H04M 1/72588; G09B 21/009; G09B 21/006

(57) ABSTRACT

Nowadays, communication and conveying the sense between deaf, blind, and other people are getting more challenging for those who do not know sign language. Also considering the worst case scenario of deaf and blind communication conditions, this problem is resolved by this new communication app as an independent one-person but two-way communication software or application App. So that people with any level of literacy and nationality or language can use this app to convey their words and phrases or their desires to deaf people on a daily basis. In this application, there are two interactive features: the first section takes audio conversations from blind or other people and plays the coherent sign language video. The second section converts the text to the audio message to make the deaf person communication possible, without knowing sign language.

This new communication method is not restricted to weather conditions, industrial environment (noise, dust and high temperatures). This application App can run on the android phone device, is very user friendly, and extendable to different languages compatibilities.

### CROSS-REFERENCE TO RELATED APPLICATIONS

### 1. U.S. Patent Documents

application No. US 20140171036, filed on Mar. 21, 2013.
application No. US 20160004831, filed on Mar. 13, 2015.

### 2. Other Publication

https://www.signlanguage.eu/en/
https://www.marleematlin.net/app/
https://rogervoice.com
https://apps.apple.com/us/app/hearyounow-your-personal-sound-amplifier/id569522474
https://www.mit.edu/c)

### STATEMENT REGARDING FEDERALLY SPONSORED RESEARCH OR DEVELOPMENT

Not applicable to this application

### THE NAMES OF THE PARTIES TO A JOINT RESEARCH AGREEMENT

Not applicable to this application

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable to this application

### STATEMENT REGARDING PRIOR DISCLOSURES BY THE INVENTOR OR A JOINT INVENTOR

Not applicable to this application

### BACKGROUND OF THE INVENTION

### 1. Field of the Invention

The present invention relates generally to communication methods and more specifically relates to a mobile device communication software with interchangeable for infinite playing audio data corresponding to sign language gestures and play sign language videos for the typed messages.

### 2. Description of Related Art

Most of the available applications are offered in two general types of instructional and dictionary, which are used, respectively, to learn the alphabet or numbers, words in sign language and to show video of sign language for typed word. The important point is that in these educational applications, it is not sufficient and comprehensive for practical use in life, and they only have an educational aspect.

On the other hand, dictionaries do not have the ability to use sentences with an interactive method. Some available applications are as follows:

An app called “Hear You Now” is designed for hypoacusis people and helps people hear conversations more clearly. In this application, you can adjust the sound pressure level according to the need. This app is also suitable for people who work in a crowded and noisy environment.

“Spread the Sign” app is also one of the best sign language dictionaries among mobile apps, and there are more than 300,000 words with the equivalent sign language image in this app. With each annual update, newer features are added to the app. With the help of “Spread the Sign”, you can have the sign language of 25 different languages in one place.

The “RogerVoice” app (beta version) helps the deaf to understand phone calls. With this app, the user will have a subtitle from each phone call.

The “Marlee Signs” app is designed to teach American sign language and is consisted of many sign language instructional videos. Therefore, in addition to the deaf, it is also suitable for people who are communicating with them on daily bases. In “Signs Marlee”, you can even type any word and learn the equivalent in sign language.

Currently, MIT university students have designed a glove that a deaf person can ware, and when he or she moves hand by using the sign language, the gesture is analyzed and the audio message of that gesture is heard.

The noticeable comparison between the introduced application and MIT gloves is that; The MIT gloves use an acceleration sensor, gyroscope, and magnetometer sensor to track sign language, give data to an electronic board, which in itself creates a total limitation, such as the high cost of this equipment and high direct maintenance cost. On the other hand, the glove also has restrictions on the environments used, such as rainy weather conditions, and in industrial environments. Given these limitations, the main question is whether this glove can easily continue to operate in such conditions, of course, if we ignore the noise from engine ignition, etc. in the industrial environment, all these cases themselves are a problem that needs to be addressed.

In the past, given the above as well as the available patents, it can be concluded that they have fundamental concerns about the field of scope, technology, and the concept of the method used. Generally, the following limitations are presented in the field of communication between hearing impaired person and hearing person:
Need to install two separate software on two different mobile devices
A software usage that requires external gadgets and by its characteristics has increased complexity and cost
A method that has limited use in environmental and working conditions i.e. rainy, snowy, foggy, noisy, physical restriction, and etc.
A one-way external medical device that prompts relating to a health survey for patients and analyzing vital data by using sensors and external devices

In the proposed application in this patent, since almost everyone in the world now has a smartphone and uses it every day, there is no need for everyone to pay an extra money to buy a new gadget, only by installing this software, this capability can be used without the restrictions mentioned above.

For instance, imagine a blind person traveling from a country to another and going to a restaurant whose accountant is a deaf person, so how can the two talk to each other? Considering that the blind can talk, which the deaf cannot hear, and the deaf can see that the blind cannot see. This is where all these problems are solved with one mobile device application APP and both of them continue their lives with one smile and hope.

The main goal of our team is that these people are not separate from society and think of a better life independently without any annoying compassion as same as every other normal person.

### SUMMARY OF THE INVENTION

This mobile device software called “Hope Tech” has been designed and developed in a way that a user can simply procure from online app stores and install on a mobile phone.

The unique advantage of our communication app software is designed as an independent communication app for one-person use. In this way, everyone including blind and deaf people can have a two-way conversation with a blind or a deaf person if only and only if one person in conversation have this new app installed on only one communication device, meaning there is no need for both persons in conversation to have their separate device equipped with the app software to be able to communicate with each other. With regard to this app, the main goal of this communication app, which is to surmount the blind and deaf people's communication difficulties would be satisfied and they are going to have the same opportunity of daily communication as a regular person in society.

This mobile device application App, which is coded with “Android Studio” programming software, can be installed on mobile phones with the Android operating system. With this application, the blind person can easily exchange any daily basis information and dialogue with the deaf person. So that, after the blind person's speech is received and the process of the equivalent sign language video has been performed by this application, on the other side, the deaf person is able to understand the blind person's speech by watching the played video through this mobile device application.

In addition, there is a tab in the mobile device application that allows the deaf person to type the answer to a blind question or request, and the typed phrase would be expressed and can be heard by any blind person, therefore, considering these two interactive features for this application App, the blind and deaf person can communicate with each level of ability and language.

Currently, this App is capable of audio processing in the original version for eight more often used languages in the world for receiving speech inputs and converting to text for playing the incorporate sign language video; English (EN), Persian/Farsi (FA), German (GE), French (FR), Italian (IT), Spanish (SP), Japanese (JP), Chinese (CH). Also supports five more often used languages in the world for receiving text inputs and converting to voice outputs through the phone device speakers; English (EN), German (GE), French (FR), Italian (IT), Japanese (JP). In addition, the number of supported languages in our application is extendable due to Google Service using based.

The program logic has been used in this application App is written in such a way that the audio processing is assisted by Google speech service, and then the analysis goes to the application App library and automatically displays the sign language video that has been uploaded in the library.

The library of words and sentences has been loaded in a way to cover as much as possible the most of daily conversations. This information can be reviewed in the library's language tab inside the software or application by any user and it gives this opportunity that the technical words or phrases database or libraries has the customization and development capability based on user queries for any professional use.

### BRIEF DESCRIPTION OF THE SEVERAL VIEWS OF THE DRAWING(S)

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is the graph showing the different layers/pages of the application

FIG. 2 is the graph showing the different coding classes used from Android Studio programming software

FIG. 3 is the graph showing the application logic and steps required for: the communication with deaf or blind people, change language, review word list based on language, and submit customization request

FIG. 4 is the application icon and main page showing with available tabs

FIG. 5 is the application “MIC”, “SPEECH”, “LIBRARY”, “CONTACT US”, and “HELP” tabs showing how constructed in details

FIG. 6 is the application “MIC” tab functionality showing the different performance condition

FIG. 7 is the application “SPEECH” tab functionality showing the performance

FIG. 8 is the application “LIBRARY” tab functionality showing the different options of performance

FIG. 9 is the application “CONTACT US” and “HELP” tabs showing the different methods to contact support team for any query and the brief instruction to how use this application

### DETAILED DESCRIPTION OF THE INVENTION

The aspects of the present invention may be used as an interactive communication for the blind and deaf person to each other or normal people. Hereinafter, the “application App” represents “the present invention”.

Considering the unique advantages of our mobile device application App is that on only one mobile device, you can have a two-way conversation between a blind and a deaf person, and there is no need for both the blind and the deaf persons to have a separate phone equipped with the software to be able to communicate with each other wherein it could be described as follows.

The user can install and run this mobile device software or App on android system mobiles with minimum version 4.0. The basic version of the application App requires a minimum of 200-megabyte memory and it could be extended based upon the user customizations.

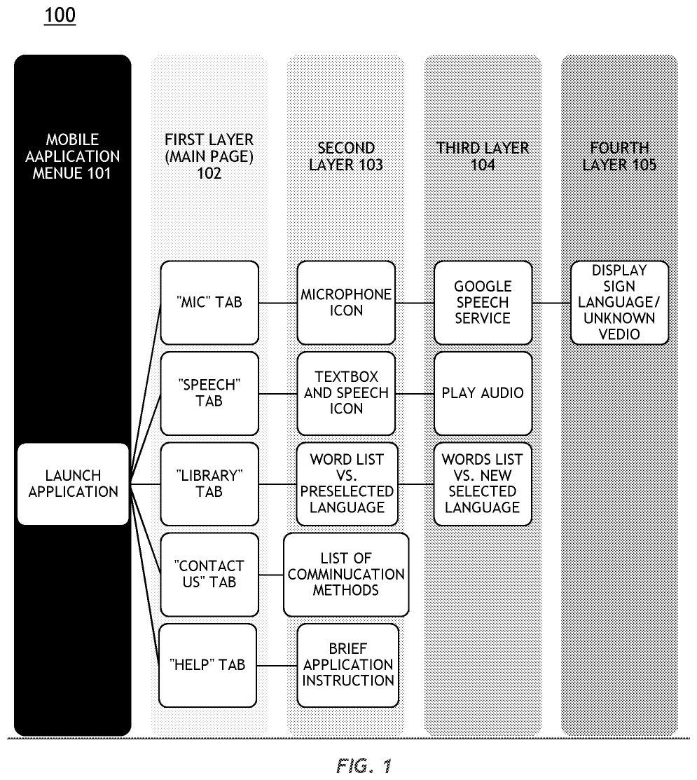

This mobile device software or App includes different layers and pages in order to provide communication capabilities for users with different demands as normal, blind, and deaf people. FIG. 1 is showing the main layers (101) of this application App. The main page in the first layer (102) includes five tabs and one selected language indicator.

The main page is showing the “MIC” tab selected as the default when the application App is opened. The second layer (103) could provide different functional capabilities based on the tab has been selected in the previous layer (first layer). Also, the third (104) and fourth (105) layers depend on which function has been used on the previous steps.

In layer 2 shown (103) in FIG. 1, there are three different functionality options “Microphone icon”, “Textbox and Speech icon”, “Words list vs. preselected language”, “List of communication methods”, and “Brief application instruction”, respectively, if “MIC”, “SPEECH”, “LIBRARY”, “CONTACT US”, or “HELP” tab has been selected in the previous step at the 1st layer.

In layer 3 (104), based on the tab has been selected from layer 1 and the function has been activated at the 2nd layer, the user would find function outcomes for “Google Speech Service”, “Play Audio”, and “Words list vs. new selected language”. In the case that the “MIC” tab has been selected, at the 3rd layer the voice data would be received in and after the audio processing, the final outcomes shown in layer 4 (105).

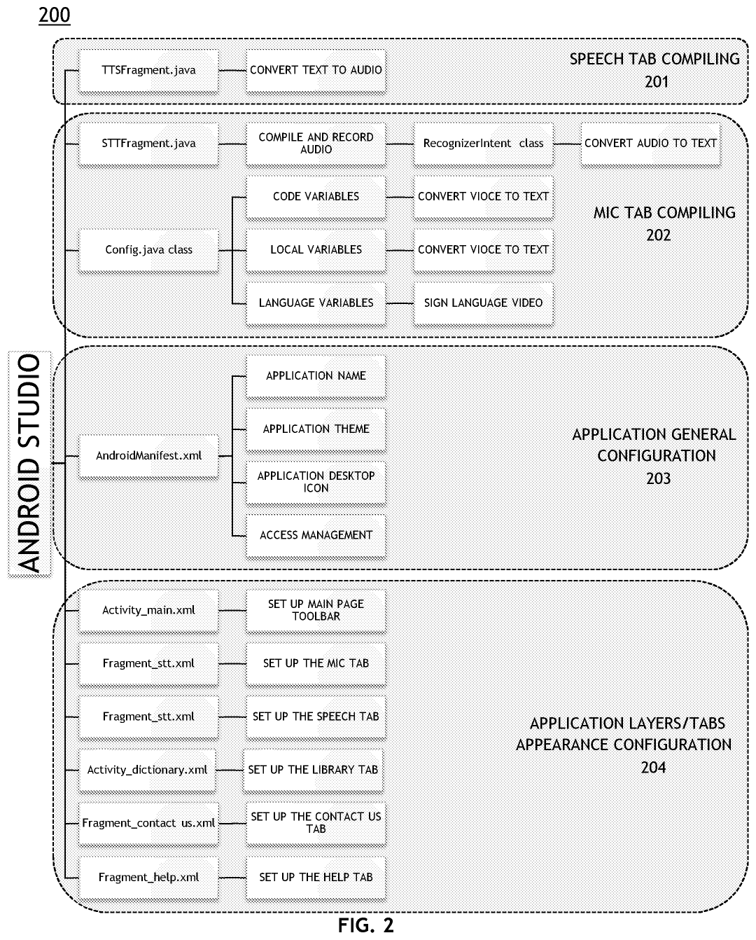

This mobile device software has been developed by using “Android Studio” programming software. In FIG. 2, the different used classes of this software are listed and categorized based on the different functions of this application.

The “TTSFragment.java” class used in conjunction with the “SPEECH” tab (201) in order to convert the user input text in “Textbox” to playable audio. The “STTFragment.java” and “Recognizerintent class” classes (202) used in conjunction with text output from the Google Speech Service by incorporating variables defined with “Config.java class”. The “Android Manifest.xml” developed to config the general view and access to the application App (203). The tabs appearances are set up with six different “.xml” (204) shown in FIG. 2.

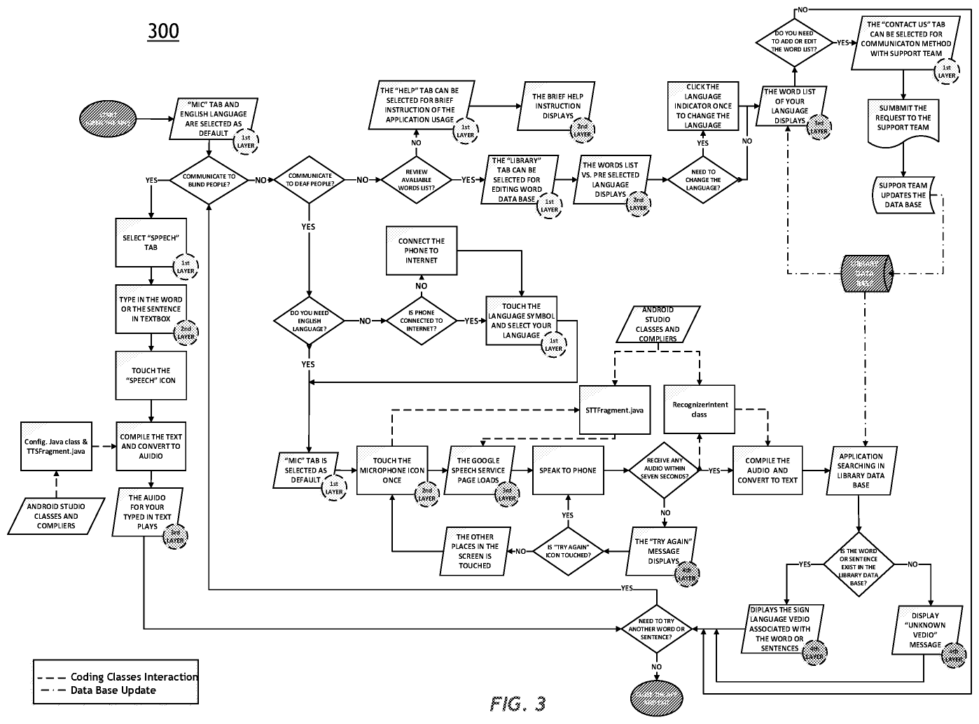

The logic which runs this application App by using Android programming classes and layers explained above is shown in FIG. 3. Also, the required steps to be used for the different functions of this application as well as reviewing the “LIBRARY” word list and submitting any customization request are presented. In FIG. 3, the interaction and connection between the “MIC” and “SPEECH” coding classes are illustrated regarding every step the user utilized.

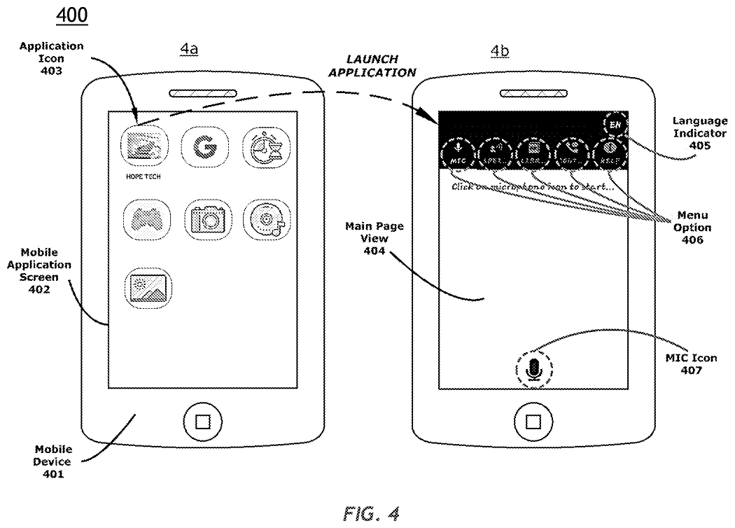

Through FIG. 4 to FIG. 9, the different functions and outcomes described above are illustrated. These figures are taken from the first actual version of this application App.

FIG. 4 is a collection of mobile device graphical user interfaces (GUIs) illustrating a sample implementation of this application in accordance with an embodiment of the inventive arrangement disclosed herein. It should be appreciated that the GUIs presented in all figures are for illustrative purposes only, and additional configurations and functionalities can be incorporated without diverging from this embodiment of the present invention.

After the application App has been downloaded from the application App store and installed on the android phone device (401), this application icon (403) will be appeared on the phone device applications screen (402). The stairs to the sky symbol elected for this application icon which represents the success and guidance path for everyone in the world regardless of people constraints and limitations.

By launching the application App, the main page view (404) shows the “MIC” tab as the default. The main page as described in (100), includes the selected language indicator (405), which is set up on the English language as default during launching the application App, and menu options (406) on the main page which could be selected by the user touching based on the required function. Each one of the tabs gets focus highlighted when selected. Whereas the “MIC” tab is the default tab on the main page, the microphone icon (407) located on the center bottom of the screen.

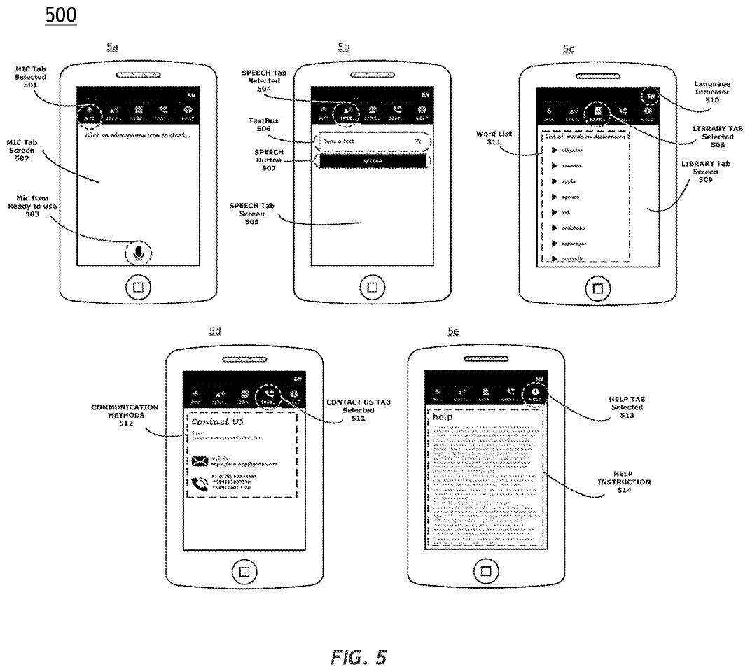

In FIG. 5, the menu options “MIC”, “SPEECH”, “LIBRARY”, “CONTACT US”, and “HELP” are illustrated more in details, respectively, within (5a), (5b), (5c), (5d), and (5e). The selected language indicator (510) is common with all menu option pages but only applicable and effective to “MIC”, “SPEECH”, and “LIBRARY” tabs.

By selecting the “MIC” tab symbol (501), the relevant screen view (502) for this tab will be depicted and the written instruction “click on microphone icon to start . . . ” and the microphone icon (503) will be exerted. This tab used for the communication of normal and blind people with a deaf person.

By selecting “SPEECH” tab symbol (504), the relevant screen view (505) for this tab will be depicted. Within this view, the textbox (506) with the written instruction “type a text” and speech button (507) will be exerted. The deaf people can use this tab functionality to communicate with the blind people.

After selecting the “LIBRARY” tab symbol (508), the relevant screen view (509) for this tab will be depicted. The word list (511) will be exerted based upon the selected language is shown in (510). This tab provides words and sentence lists stored in the library database based upon the selected language.

The “CONTACT US” tab (511) and “HELP” tab (513) are used as informational pages, respectively, to represent communication methods list (512) to contact support team for any query and to understand the general functionality and usage instruction for this application (514).

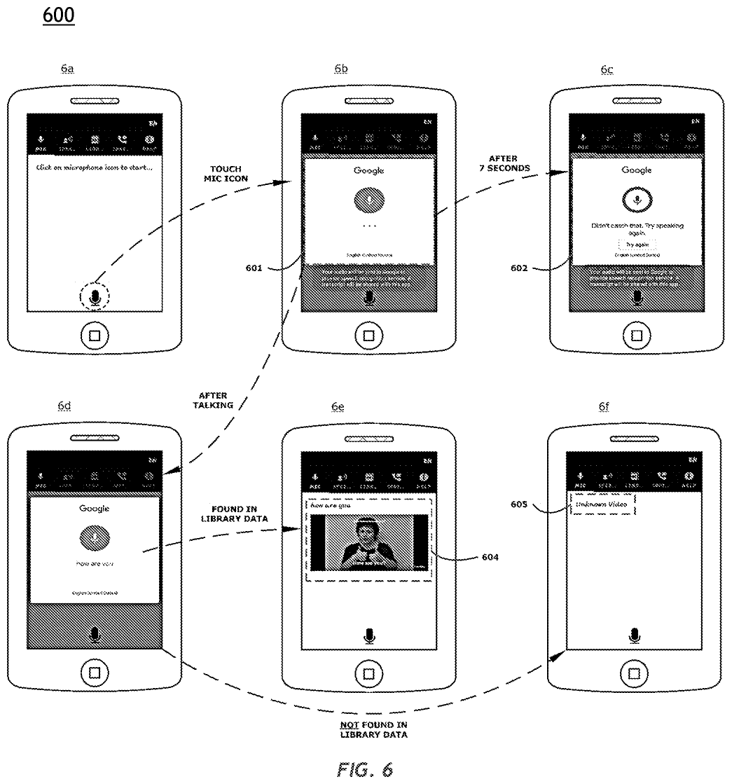

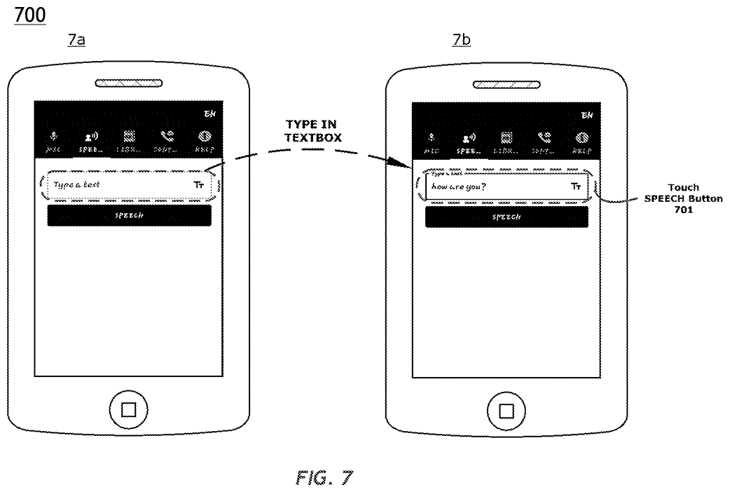

Regarding the logic and steps shown in FIG. 3, the actual GUIs illustrations of this application are shown in FIG. 6 and FIG. 7. All examples used within these figures only represent as a reference functionality to understand the logic and different conditions could happen during the application performance, therefore, the shown recognized text of voice and the text in these figures can be incorporated with the different recorded voice or text, respectively, in “MIC” and “SPEECH” tabs. The examples are shown in English language and using “How are you” sentence.

In FIG. 6 (6a), by selecting the “MIC” tab and clicking on the microphone icon, the Google Speech Service interface view (601) depicted and asking for saying something (6b). Based on the user response, there will be two situations. First, within seven seconds if any voice is not captured, the written message “didn't catch that. Try speaking again” with the “Try again” button (602) will be exerted shown in (6c) view. The user can proceed to say something by clicking on try again button and it returns to the screen view (601). Second, within seven seconds if a voice is captured, the screen changes to (6d) and showing the recognized voice in the format of the text, then in this stage, there are another two different situations in this condition, if the recognized voice is available in the application App library database, the sign language video (604) will be displayed in (6e) view, if the recognized voice is not available in the database, the “Unknown video” message (605) will be displayed which is shown in (6f) view. Also, these two stage logics can be followed in FIG. 3 flowchart.

FIG. 7 is illustrating the “SPEECH” tab functionality views. The user by selecting this tab (7a), can type in the word or the sentence that required the reading voice to be played within the provided text box. Then in (7b) view, by clicking the speech button (701), the reading voice starts to play through the phone device speakers.

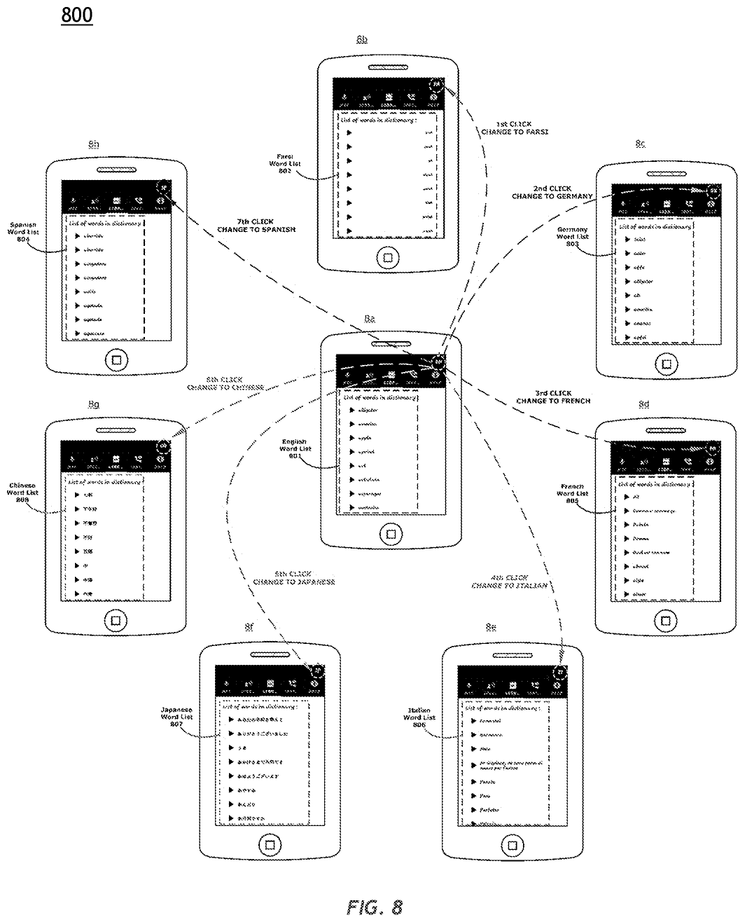

The third tab, “LIBRARY”, functionality is shown in FIG. 8. Regarding the first base version of the application, the current library data base provides eight languages; English (EN), Persian/Farsi (FA), German (GE), French (FR), Italian (IT), Spanish (SP), Japanese (JP), Chinese (CH). This capability might be extended based on the user request.

By selecting the “LIBRARY” tab, as default, the words list (801) is depicted in (8a) view based on the last selected language from the other tabs, the preselected language in (8a) is English. In order to switch between eight languages word lists, every time by clicking on the selected language indicator the language will be changed, and the relevant word list shows on the screen. The language change order follows as English (EN), Persian/Farsi (FA), German (GE), French (FR), Italian (IT), Spanish (SP), Japanese (JP), Chinese (CH) which are shown, respectively, (801) in (8a) view, (802) in (8b) view, (803) in (8c) view, (804) in (8d) view, (805) in (8e) view, (806) in (8f) view, (807) in (8g) view, and (808) in (8h) view.

The user can play any incorporated sign language video with each one of the words, by clicking on the intended word.

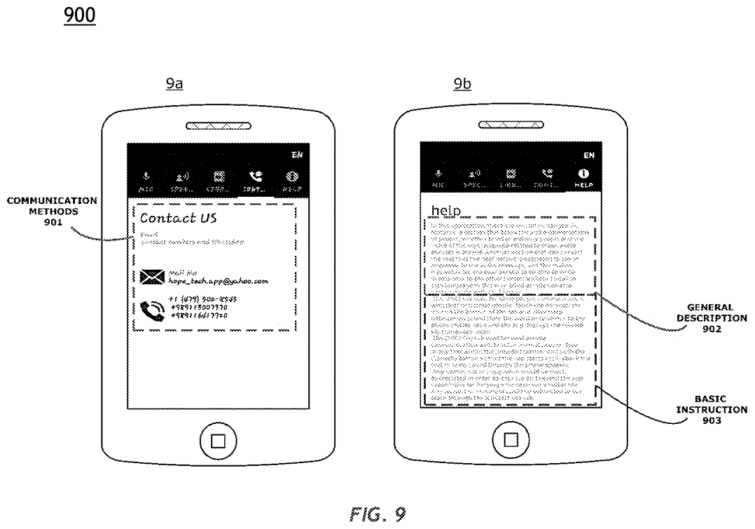

In FIG. 9 (9a), the communication methods list (901) will be illustrated by clicking on the “CONTACT US” tab. In this list, the different contact information, email address and phone numbers, for the user has been provided in the case of any query. The provided phone numbers can be used for “WhatsApp” communication, too.

In FIG. 9 (9b), the general description (902) about this application following with the basic instructions (903) are provided. Foe any further help, the user might submit a request by using one of the communication methods in “CONTACT US” tab.

The flowchart and block diagrams in the Figures illustrate the architecture, functionality, and operation of possible implementations of systems, methods and programming according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and programming instructions.

The invention claimed is:

1. A method of two-way communication between a deaf person who uses sign language and a blind-normal person who speaks comprising:
a) receiving a text input from the deaf person and converting the text to speech voice for the blind-normal person by using only one communication device with real-time software;
b) receiving speech voice from the blind-normal person and converting the speech to a sign language video for the deaf person by using the same communication device with real-time software; and
wherein the deaf person and blind-normal person use only one communication device with real-time software to communicate.

2. The method of claim 1, wherein the only used communication device performs with Google Services support for real-time converting speech to text.

3. The method of claim 1, wherein the communication device is only one phone device without any other external gadgets or assisting devices.

4. The method of claim 1, wherein the communication device works in any environment conditions.

5. The method of claim 1, wherein the communication device has unlimited and extendable different languages support as a built-in feature.

6. The method of claim 1, wherein the communication device has databases or libraries of technical words and phrases with customization capability based on user queries for professional use.

7. A system of two-way communication between a deaf person who uses sign language and a blind-normal person who speaks comprising:
a) a communication device receives a text input from the deaf person and real-time convert the text to speech for the blind-normal persons;
b) the same communication device receives speech from the blind-normal persons and real-time convert the speech to a sign language video for the deaf person; and
wherein the deaf person and blind-normal person use only one communication device with real-time software to communicate.

8. The system of claim 7, wherein the only used communication device performs with Google Services support for real-time converting speech to text.

9. The system of claim 7, wherein the communication device is only one phone device without any other external gadgets or assisting devices.

10. The system of claim 7, wherein the communication device works in any environment conditions.

11. The system of claim 7, wherein the communication device has unlimited and extendable different languages support as a built-in feature.

12. The system of claim 7, wherein the communication device has databases or libraries of technical words and phrases with customization capability based on user queries for professional use.

13. A method of two-way communication between a deaf person who uses sign language and a blind-normal person who speaks using a built-in program algorithm of real-time software comprising:
providing only one communication device supports dual usage real-time software for deaf and blind-normal persons; and
wherein said the dual usage real-time software providing:
a) a text-to-speech real-time software for the deaf person;
b) a speech-to-sign language real-time software for the blind-normal person;
and wherein when the blind-normal person communicates to the deaf person, the said dual usage real-time software converts inputs from the following steps:
i) a speech is taken by the communication device
ii) the speech is converted to a text by Goggle service
iii) a sign language video corresponding to the text is displayed to the deaf person on the same communication device
and wherein when the deaf person communicates to others, the said dual usage real-time software receives a typed text from a provided text box and converts it to an audible speech for the blind-normal person.

14. The method of claim 13, wherein the only used communication device performs with Google Services support for real-time converting speech to text.

15. The method of claim 13, wherein the communication device is only one phone device without any other external gadgets or assisting devices.

16. The method of claim 13, wherein the communication device works in any environment conditions.

17. The method of claim 13, wherein the communication device has unlimited and extendable different languages support as a built-in feature.

18. The method of claim 13, wherein the communication device has databases or libraries of technical words and phrases with customization capability based on user queries for professional use.
